(19) United States
(12) Patent Application Publication
(10) Pub. No.: US 2013/0246779 A1
(43) Pub. Date: Sep. 19, 2013

(54) Calling Firmware Runtime Services of Basic Input Output System

(71) Applicant: Jack Wang, Milpitas, CA (US)

(72) Inventor: Jack Wang, Milpitas, CA (US)

(21) Appl. No.: 13/789,298

(22) Filed: Mar. 7, 2013

(30) Foreign Application Priority Data
Mar. 9, 2012 (TW) 101108158

(51) Int. Cl. G06F 21/57

(52) U.S. Cl. CPC G06F 21/572
USPC 713/2

(57) ABSTRACT

Approaches for calling firmware runtime services of a basic input/output system. A special globally unique identifier and a name are sent to PURE virtual variable stores by an operating system. The PURE virtual variable stores identify the special globally unique identifier and the name, for example, by checking in the PURE virtual variable stores to ascertain if the special identifier and the name correspond to a firmware runtime service of the basic input/output system. A corresponding firmware runtime service of the basic input/output system is called. The firmware runtime service of the basic input output system then executes.

### CLAIM OF PRIORITY

This patent application claims priority to Taiwanese patent application 101108158, filed Mar. 9, 2012, entitled “Method for Calling Firmware Runtime Services of Basic Input Output System,” invented by Jack Wang, the contents of which are hereby incorporated by reference in their entity for all purposes as if fully set forth herein.

### FIELD OF THE INVENTION

Embodiments of the invention generally relate to calling firmware runtime services of a basic input/output system (BIOS).

### BACKGROUND

As a new basic input/output system (BIOS), UEFI (Unified Extensible Firmware Interface) is gaining momentum and is becoming more and more popular. In traditional BIOS applications, an operating system (OS) can call all firmware runtime services (FRS) through SMI (System Management Interrupt). However, since new-generation BIOS employs UEFI, new platforms may not support SMI, and as a result, a part of the FRS may not be useable by the OS.

### SUMMARY

Embodiments of the invention are directed towards calling firmware runtime services of a basic input/output system. An embodiment of the invention may include sending a special globally unique identifier and a name to PURE virtual variable stores by an operating system, identifying the special globally unique identifier and the name by the PURE virtual variable stores, checking in the PURE virtual variable stores if the special identifier and the name corresponds to a firmware runtime service of the basic input/output system, and calling a corresponding firmware runtime service of the basic input/output system, and executing the firmware runtime service of the basic input output system.

### BRIEF DESCRIPTION OF THE DRAWINGS

Embodiments of the invention may be described according to the appended drawings. Wherever possible, the same reference numbers will be used throughout the drawings to refer to the same or like portions. In the drawings:

FIG. 1 is a system block diagram illustrating a method of calling firmware runtime services of a basic input/output system in accordance with an embodiment of the present invention;

FIG. 2 is a flow diagram illustrating a method of calling firmware runtime services of a basic input/output system in accordance with an embodiment of the present invention;

FIG. 3 is a flow diagram illustrating an exemplary volume control application in accordance with an embodiment of the present invention; and

FIG. 4 is a flow diagram illustrating an exemplary firmware volume control variable driver in accordance with an embodiment of the present invention.

### DETAILED DESCRIPTION

Embodiments of the invention relate to calling firmware runtime services of a basic input/output system. Embodiments may operate by identifying a special globally unique identifier and a name and calling a firmware runtime service of the basic input output system that corresponds to the special globally unique identifier and the name. Embodiments may operate in an environment termed “PURE” (Phoenix UEFI Runtime Environment); the term PURE may be used throughout the specification.

As mentioned previously, new-generation BIOS uses UEFI, while UEFI may not support SMI such that OS cannot call all FRS through SMI. Embodiments operate under a new approach, which sends an FRS request in virtual variable form to OS through UEFI variable access service to achieve the purpose of calling FRS. PURE includes at least one PURE virtual variable store, which is a driver appended under OS. When the OS calls firmware runtime services, a set of virtual variable, including a GUID (Globally Unique Identification) and a name is sent. The GUID is a non-repeatable unique identification number in the computer system to identify an object of a non-repeatable number. The GUID is a fixed globally unique identifier to identify the set of virtual variable. The name is a variable name. In the application of PURE, the name may be a different variable name that matches the same GUID in order to call the same set of the virtual variable store.

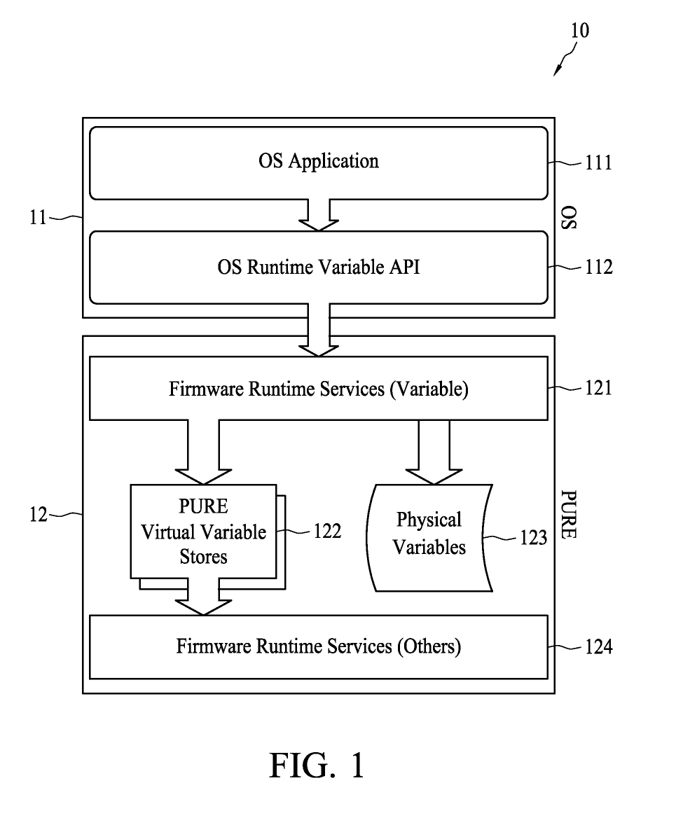

FIG. 1 is a system block diagram 10 illustrating a method of calling firmware runtime services of a basic input/output system (BIOS) in accordance with an embodiment of the present invention. Referring to FIG. 1, the system block diagram 10 may include an operating system (OS) 11 and PURE 12. The OS 11 includes an OS application 111 and an OS runtime variable application program interface (API) 112. The PURE 12 includes firmware runtime services (variable) 121, PURE virtual variable stores 122, physical variables 123 and firmware runtime services (others) 124.

The OS application 111 represents a native OS application which needs to use the runtime services provided by firmware, that is, firmware runtime services.

The OS runtime variable API 112 represents a native OS API for accessing UEFI variables. In one embodiment according to the present invention, the UEFI variables may include “get” and “set” variables.

The firmware runtime services (variable) 121 represents variable runtime services provided by the BIOS 10.

The PURE virtual variable stores 122 represents drivers responsible for handling special runtime service calls.

The physical variables 123 represent real variables stored in storage media such as a flash read-only memory (ROM).

The firmware runtime services (others) 124 represents other runtime services to be dispatched by the drivers, i.e., PURE virtual variable stores 122.

In operation, when the OS 11 would like to perform a firmware runtime service, the OS application 111 sends a function variable to the PURE 12 through the OS runtime variable API 112. In one embodiment, the function variable may include a time variable or a volume variable. The variable firmware runtime services 121 of the PURE 12 receive a globally unique identifier (GUID) and a name of a function variable, which represent the function and a variable name of a command. If the function variable does not include any GUID or name, the physical variables 123 are searched for access to a physical variable. If no physical variable is identified in the physical variables 123, an error status is reported.

Accordingly, when the OS 11 performs the other firmware runtime services 124, the OS application 111 sends a function variable to the PURE 12 through the OS runtime variable API 112. The function variable includes a GUID and a name, wherein the GUID is a specific globally unique identifier used to identify the function variable and access a corresponding command in the PURE virtual variable stores 122 so as to call the other firmware runtime services 124. The other firmware runtime services 124 can only be called through the PURE virtual variable stores 122, and cannot be directly called by the OS 11. If the GUID finds no corresponding command in the PURE virtual variable stores 122, an error status is reported.

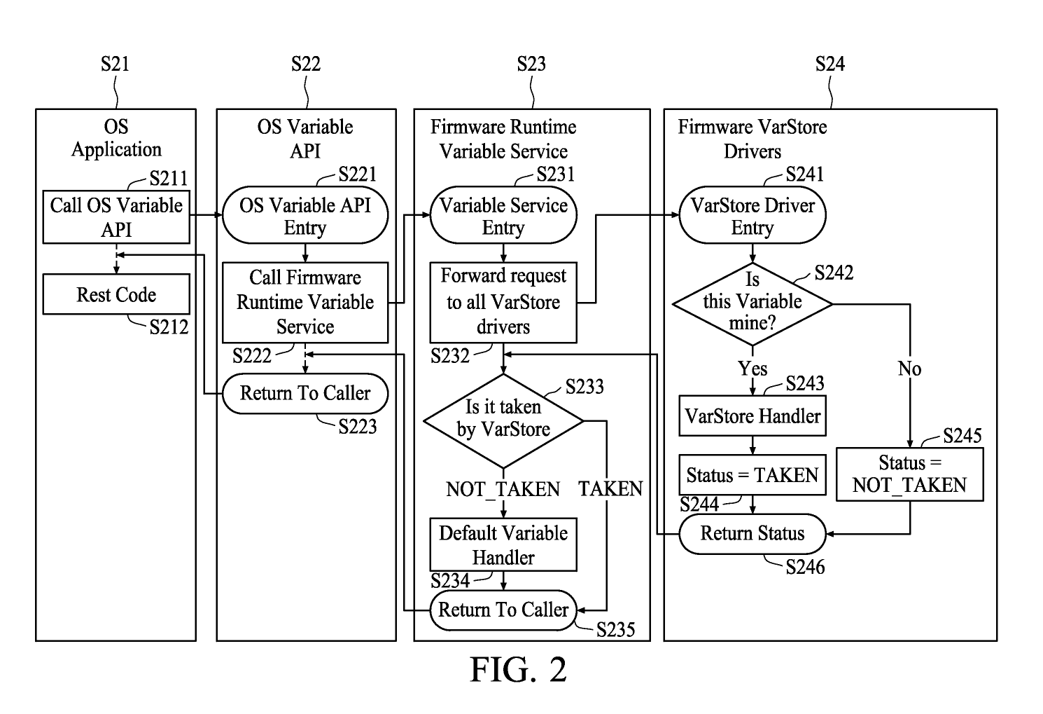

FIG. 2 is a flow diagram illustrating a method of calling firmware runtime services of the BIOS 10 in accordance with an embodiment of the present invention. Referring to FIG. 2, the method may include major steps S21 to S24, namely OS application step S21, OS variable API step S22, firmware runtime variable service step S23 and firmware variable store drivers step S24.

Also referring to FIG. 1, OS variable API 112 is called at step 211. The OS variable API 112 provides a function variable at step S221. Next, at step S222, a firmware runtime variable service is called.

Based on the function variable, it is determined whether a request is to be sent. If affirmative, the request is sent at step S232 to the drivers of all PURE virtual variable stores 122. In the present embodiment, the PURE virtual variable stores 122 include a plurality of virtual stores, which determine and execute a command associated with the function variable.

At step S242, it is determined whether the function variable corresponds to a driver in the PURE virtual variable stores 122. If affirmative, at step S243, the function variable is processed by a variable handler such as a processing program. Furthermore, the status is set as “TAKEN” at step S244 and is transmitted at step S246 to the firmware runtime variable service step S23.

If at step S242 the function variable does not correspond to any driver in the PURE virtual variable stores 122, at step S245, the status is set as “NOT_TAKEN” and is transmitted at step S246 to the firmware runtime variable service step S23.

In response to the status as TAKEN at step S233, the process returns at step S235 to a caller, for example, a calling program. On the other hand, in response to the status as NOT_TAKEN at step S233, a default variable handler at step S234 finds a variable value in the physical variables 123 and accesses a physical variable. If no corresponding variable is found, an error status is reported. Next, the process returns at step S235 to the caller.

Subsequent to the step S235, a time command is executed at step S223 and then the process returns to the caller, which is the processing procedure of the OS 11. Next, at step S212 the rest program codes are processed.

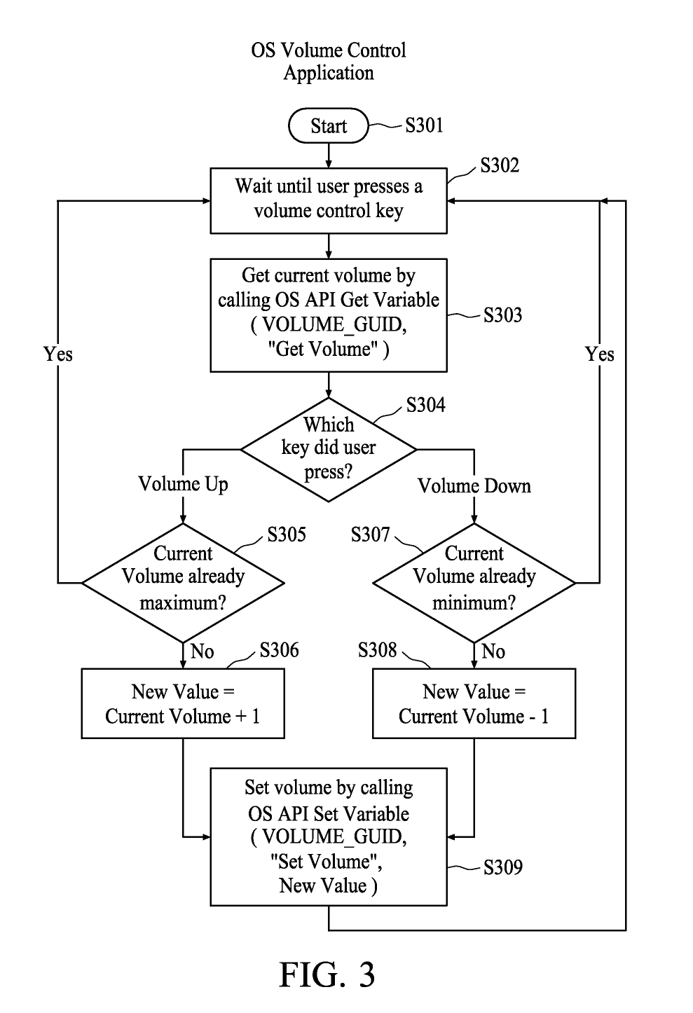

FIG. 3 is a flow diagram illustrating an exemplary volume control application in accordance with an embodiment of the present invention. Referring to FIG. 3, at step S302, a volume control key being pressed by a user is detected. Then at step S303, the current volume is obtained by calling an OS API, GetVariable (VOLUME_GUID, “GetVolume”). In the function GetVariable (xxx), GetVariable represents the name of an API, VOLUME_GUID is a globally unique identifier, and “GetVolume” is the name of a variable. The VOLUME_GUID and “GetVolume” together constitute a virtual variable. The virtual variable corresponds to or matches a command in the PURE virtual variable stores 122 so as to execute a firmware runtime service.

At step S304, which volume key is pressed by the user is determined. If the pressed key is a “volume up” key, at step S305. In step S305, it is determined whether the maximum volume is reached. If affirmative, the process returns back to the step S302 and repeats the steps S303 and S304 when the volume control key is pressed.

If the current volume is not maximum, at step S306, the current volume is increased by one unit, New Value=Current Volume+1.

Next, at step S309, the current volume is set by calling an OS API, SetVariable (VOLUME_GUID, “SetVolume”, new value). Now, the volume is changed, i.e., increased. The process returns back to the step S302 and repeats the steps S303 and S304 when the volume control key is pressed.

If at step S304 the pressed key is a “volume down” key, then at step S307, it is determined whether the minimum volume is reached. If affirmative, the process returns back to the step S302 and repeats the steps S303 and S304 when the volume control key is pressed.

If the current volume is not minimum, at step S308, the current volume is decreased by one unit, New Value=Current Volume−1.

Next, at step S309, the current volume is set by calling the OS API, SetVariable (VOLUME_GUID, “SetVolume”, new value). Now, the volume is changed, i.e., decreased. The process returns back to the step S302 and repeats the steps S303 and S304 when the volume control key is pressed.

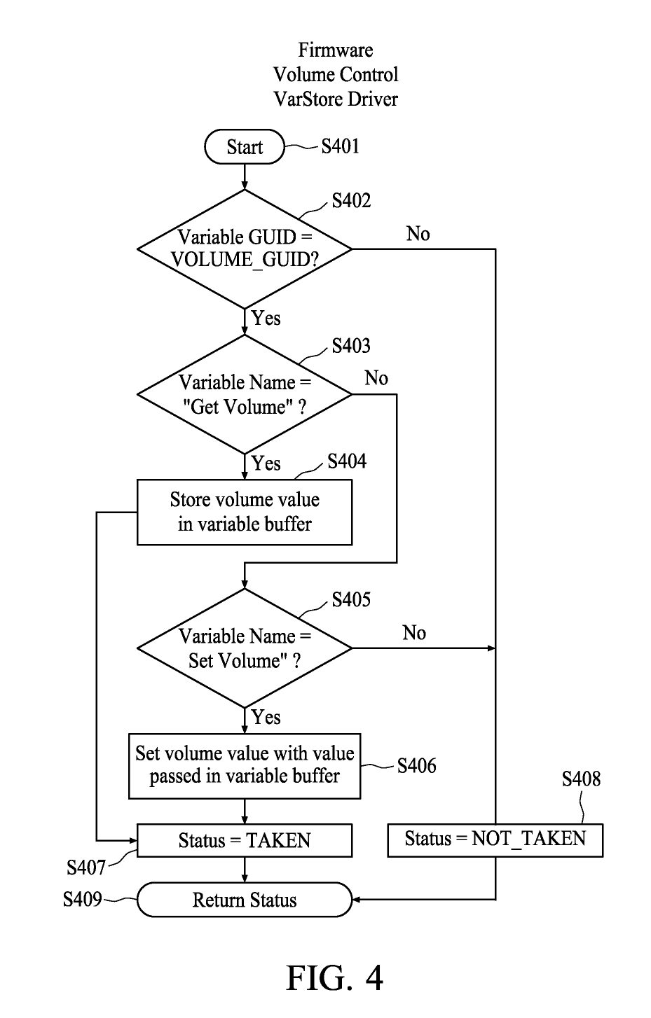

FIG. 4 is a flow diagram illustrating an exemplary firmware volume control variable driver in accordance with an embodiment of the present invention. Referring to FIG. 4, at step S402, it is determined whether a variable GUID matches VOLUME_GUID, i.e., variable GUID=VOLUME_GUID.

If not, at step S408, the status is set as NOT_TAKEN and transmitted at step S409.

If affirmative, at step S403, it is determined whether a variable name matches “GetVolume”, i.e., variable name=“GetVolume.”

If affirmative, the volume value is stored in a variable buffer at step S404. Then at step S407, the status is set as TAKEN.

If not, at step S405, it is determined whether the variable name matches “SetVolume.” If affirmative, at step S406, the volume value is set with a value in the variable buffer, and then at step S407 the status is set as TAKEN. If the variable name does not match “SetVolume,” at step S408, the status is set as NOT_TAKEN.

In the embodiment of the present invention, the method can solve the problem with an OS in calling firmware runtime services of BIOS in new UEFI. In the embodiments of the present invention, a set of virtual variable, including a GUID and a name, is sent through OS runtime variable API to PURE virtual variable stores, where a corresponding command may be identified in order to call a corresponding firmware runtime service. The method of the present invention can solve the issue of compatibility between new UEFI and new OS.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of calling firmware runtime services of a basic input/output system (BIOS) that supports UEFI (Unified Extensible Firmware Interface), the method comprising:
transmitting a virtual variable including a globally unique identifier (GUID) and a name to virtual variable stores by an operating system (OS);
identifying the virtual variable by the virtual variable stores;
checking in the virtual variable stores if the virtual variable corresponds to a firmware runtime service of the BIOS, and calling the firmware runtime service of the BIOS; and
executing the firmware runtime service of the BIOS.

2. The method of claim 1, wherein one of the virtual variable stores, in response to the GUID and the name, calls a program in the firmware runtime services of the BIOS, to execute the program in the UEFI by the OS.

3. The method of claim 1, wherein the GUID and the name are sent by an OS application.

4. The method of claim 3, wherein the OS application sends the GUID and the name to an OS runtime variable application program interface (API).

5. The method of claim 4, wherein the OS runtime variable API sends the GUID and the name to variable runtime services provided by the BIOS.

6. The method of claim 5, wherein the GUID and the name is sent to the virtual variable stores via the variable runtime services.

7. The method of claim 1, wherein the GUID is to identify a firmware runtime service of the BIOS and the name is a variable name.

8. The method of claim 1, wherein the step of calling the firmware runtime services of the BIOS comprises using different GUIDs.

9. The method of claim 1, wherein the step of calling the firmware runtime services of the BIOS comprises using a same GUID and different names.

10. The method of claim 1, wherein each of the virtual variable stores comprise a driver.

11. A tangible computer-readable storage medium storing one or more sequences for instructions for calling firmware runtime services of a basic input/output system (BIOS) that supports UEFI (Unified Extensible Firmware Interface), wherein execution of the one or more sequences of instructions by one or more processors causes:
transmitting a virtual variable including a globally unique identifier (GUID) and a name to virtual variable stores by an operating system (OS);
identifying the virtual variable by the virtual variable stores;
checking in the virtual variable stores if the virtual variable corresponds to a firmware runtime service of the BIOS, and calling the firmware runtime service of the BIOS; and
executing the firmware runtime service of the BIOS.

12. The tangible computer-readable storage medium of claim 11, wherein one of the virtual variable stores, in response to the GUID and the name, calls a program in the firmware runtime services of the BIOS, to execute the program in the UEFI by the OS.

13. The tangible computer-readable storage medium of claim 11, wherein the GUID and the name are sent by an OS application.

14. The tangible computer-readable storage medium of claim 13, wherein the OS application sends the GUID and the name to an OS runtime variable application program interface (API).

15. The tangible computer-readable storage medium of claim 14, wherein the OS runtime variable API sends the GUID and the name to variable runtime services provided by the BIOS.

16. The tangible computer-readable storage medium of claim 15, wherein the GUID and the name is sent to the virtual variable stores via the variable runtime services.

17. The tangible computer-readable storage medium of claim 11, wherein the GUID is to identify a firmware runtime service of the BIOS and the name is a variable name.

18. The tangible computer-readable storage medium of claim 11, wherein calling the firmware runtime services of the BIOS comprises using different GUIDs.

19. The tangible computer-readable storage medium of claim 11, wherein calling the firmware runtime services of the BIOS comprises using a same GUID and different names.

20. The tangible computer-readable storage medium of claim 11, wherein each of the virtual variable stores comprise a driver.
